(19) United States
(12) Patent Application Publication
(10) Pub. No.: US 2024/0349711 A1
(43) Pub. Date: Oct. 24, 2024

(54) LURE STORAGE DEVICE

(71) Applicant: Luke Opelt, Brisbane (AU)

(72) Inventor: Luke Opelt, Brisbane (AU)

(21) Appl. No.: 18/580,825

(22) PCT Filed: Jul. 14, 2022
(86) PCT No.: PCT/AU2022/050735

§ 371 Date: Jan. 19, 2024

(30) Foreign Application Priority Data
Jul. 19, 2021 (AU) 2021104301
Jul. 19, 2021 (AU) 2021206795

(51) Int. Cl. A01K 97/04

(52) U.S. Cl. CPC A01K 97/04

(57) ABSTRACT

A lure storage device having a compartment portion defining an internal space, the internal space adapted to at least partially accommodate a lure, a cover portion hingedly attached to the compartment portion, the cover portion movable relative to the compartment portion between a closed position in which the cover portion abuts and substantially closes access to the internal space internal of the compartment portion, and an open position in which the internal space is accessible, and a catchment portion attached to one of the compartment portion or the cover portion, the catchment portion movable between an unlocked condition in which the compartment portion and the cover portion can move between the open position and the closed position, and a secured condition in the closed position in which the catchment portion is releasably attached to the other of the compartment portion or the cover portion and retains the compartment portion and the cover portion in the closed position. In the closed position, the compartment portion and the cover portion define a recess adapted to accommodate a fishing line attached to the lure.

### CROSS REFERENCE TO RELATED APPLICATIONS

This application is the United States national phase of International Patent Application No. PCT/AU2022/050735 filed Jul. 14, 2022, and claims priority to Australian Patent Application Nos. 2021104301 and 2021206795 filed Jul. 19, 2021, the disclosures of which are hereby incorporated by reference in their entireties.

### BACKGROUND OF THE INVENTION

### Field of the Invention

The present invention relates to a lure storage device. The present invention has particular but not exclusive application for storing fishing lures. The patent specification describes this use but it is by way of example only and the invention is not limited to this use.

### Description of Related Art

Fishing lures are used to attract a fish's attention. Lures also typically replace the need to use bait when fishing. In some cases lures can be used with bait, however lures can be used with an attractant to provide substantially the same effect without the need to store or handle bait.

A benefit of lures is that they can be reused multiple times, unlike most bait which is typically hooked onto a fishing hook.

Some lures can be left on a fishing line without any problems. However, a problem with some types of lures is that they need to be taken off a fishing line after each use to avoid the lure degrading, drying out or losing its attractant.

This can be problematic as a portion of the fishing line typically needs to be cut to remove the lure and subsequently the fishing line needs to be retied to the lure when the lure is to be used again.

A problem with cutting the fishing line and retying the knot is that an inferior knot could be tied, leading to the loss of the lure while fishing. Another problem that could occur is when a leader line is used, each time the lure is cut from the leader line and retied, the leader line is shortened, requiring frequent replacement of the leader line portion and the tying of complicated knots.

### OBJECT OF THE INVENTION

It is an object of the present invention to overcome or at least alleviate one or more of the above mentioned problems with lures and/or provide the consumer with a useful or commercial choice.

### SUMMARY OF THE INVENTION

In one aspect, the present invention broadly resides in a lure storage device having
a compartment portion defining an internal space, the internal space adapted to at least partially accommodate a lure;
a cover portion hingedly attached to the compartment portion, the cover portion movable relative to the compartment portion between a closed position in which the cover portion abuts the compartment portion and substantially closes access to the internal space internal of the compartment portion, and an open position in which the internal space is accessible; and
a catchment portion attached to one of the compartment portion or the cover portion, the catchment portion movable between an unlocked condition in which the compartment portion and the cover portion can move between the open position and the closed position, and a secured condition in the closed position in which the catchment portion is releasably attached to the other of the compartment portion or the cover portion and retains the compartment portion and the cover portion in the closed position,
wherein in the closed position, the compartment portion and the cover portion define a recess adapted to accommodate a fishing line attached to the lure.

Preferably, the cover portion defines an internal space. Preferably the cover portion has a shape that is substantially the same as the compartment portion.

Preferably the lure storage device includes a hinge portion located between the compartment portion and the cover portion, the hinge portion hingedly attaching the compartment portion to the cover portion. Preferably the hinge portion is integrally formed with the compartment portion and the cover portion.

Preferably the lure storage device includes an attachment portion. Preferably the attachment portion is located on an outer surface of the compartment portion or the cover portion. Preferably the attachment portion includes an aperture. Preferably the attachment portion is adapted to be attached to a fishing pole using a lanyard, string or rope or the like. Preferably in use, when the lure storage device is suspended by the attachment portion, the recess is located towards an upper portion of the lure storage device.

Preferably the lure storage device includes a padding member. Preferably the padding member is adapted to cushion a lure when the lure is located within the lure storage device in the closed position. Preferably the padding member is located at least partially within one of the compartment portion or the cover portion. More preferably the padding member is located within the compartment portion. Preferably the padding member is absorbent. Preferably the padding member is adapted to retain a liquid which can be transferred to the lure when the lure is located within the lure storage device in the closed position. Preferably the liquid is a chemical attractant. Preferably the padding member is made of a foamed material. Preferably the foamed material is an open foamed material. In another embodiment, the padding member is a brush pad. Preferably the brush pad is adapted to retain a liquid which can be transferred to the lure when the lure is located within the lure storage device in the closed position. Preferably the padding member is replaceable. In one embodiment, the padding member includes an adhesive strip to stick it to the respective one of the compartment portion or the cover portion. In one embodiment, the padding member has two portions, one non-absorbent portion underneath an absorbent top portion to retain the liquid which can be transferred to the lure when the lure is located within the lure storage device in the closed position. Preferably the liquid is a scent gel.

In one embodiment, the lure storage device includes two padding members. Preferably each of the compartment portion and the cover portion includes a padding member.

Preferably the catchment portion is attached to the cover portion. Preferably the catchment portion is hingedly attached to the cover portion. Preferably the compartment portion includes an indentation which can accommodate at least part of the catchment portion in the secured condition. Preferably the catchment portion includes a lip portion which can engage with part of the indentation to releasably secure the catchment portion to the compartment portion. Preferably the indentation includes a groove with which the lip portion can engage to releasably secure the catchment portion to the compartment portion.

Preferably in the closed position and secured condition, the lure storage device is elongate. Preferably the lure storage has a lower end and an upper end. Preferably the recess is defined towards the upper end. Preferably the attachment member is located towards the upper end.

Preferably the lure device is made predominantly from a plastic material. In another embodiment, the lure device is made predominantly from a mettalic material or from a composite material.

Preferably the lure storage device includes a seal member. Preferably the seal member is adapted to at least partially seal between the compartment portion and the cover portion when the compartment portion and the cover portion are in the closed condition. Preferably the seal member is attached to one of the compartment portion or the cover portion. In one embodiment, each of the compartment portion and the cover portion has a seal member. In one embodiment, each seal member is integrally formed with the compartment portion and/or the cover portion. In one embodiment, the seal member is absent from the recess that is defined between the compartment portion and the cover portion. In another embodiment, the seal member is present in the recess that is defined between the compartment portion and the cover portion. Preferably in this embodiment, the seal member is deformable to accommodate a fishing line located within the recess.

Preferably the seal member is adapted to retain a liquid in the lure storage device in the closed condition.

Preferably the fishing line has a diameter between 0.1 mm and 3 mm.

Preferably the lure is a fishing lure.

In a further aspect, the present invention broadly resides in a method of storing a lure using a lure storage device as described in this specification, including the steps of locating the lure in the compartment portion or the cover portion;
adjusting a fishing line attached to the lure such that in the closed condition, the fishing line is located in the recess;
moving the compartment portion relative to the cover portion to a closed position; and
moving the catchment portion from an unlocked condition to a secured condition in which the catchment portion releasably secures the compartment portion and the cover portion in the closed position.

Preferably the method further includes the step of providing a padding member to cushion the lure when the lure is located within the lure storage device in the closed position.

Preferably the method further includes the step of deforming a seal member to accommodate the fishing line in the recess.

In another aspect, the present invention broadly resides in a lure storage device having
a compartment portion defining an internal space, the internal space adapted to at least partially accommodate a lure;
a cover portion hingedly attached to the compartment portion, the cover portion movable relative to the compartment portion between a closed position in which the cover portion abuts the compartment portion and substantially closes access to the internal space internal of the compartment portion, and an open position in which the internal space is accessible;
a catchment portion attached to one of the compartment portion or the cover portion, the catchment portion movable between an unlocked condition in which the compartment portion and the cover portion can move between the open position and the closed position, and a secured condition in the closed position in which the catchment portion is releasably attached to the other of the compartment portion or the cover portion and retains the compartment portion and the cover portion in the closed position;
a padding member located at least partially within one of the compartment portion or the cover portion, the padding member adapted to cushion the lure when the lure is located within the lure storage device in the closed position; and
a seal member adapted to at least partially seal between the compartment portion and the cover portion when the compartment portion and the cover portion are in the closed condition,
wherein in the closed position, the compartment portion and the cover portion define a recess adapted to accommodate a fishing line attached to the lure.

Preferably the padding member is located in the compartment portion. Preferably the cover portion includes an additional padding member. Preferably the additional padding member is located in the other of the compartment portion or the cover portion.

Preferably each padding member is adapted to retain a liquid which can be transferred to the lure when the lure is located within the lure storage device in the closed position. Preferably the liquid is a chemical attractant in the form of a scent.

It will be understood that the lure storage device can also be referred to as a lure scent applicator.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a front view of a lure storage device according to an embodiment of the present invention;

FIG. 2 is a rear view of the lure storage device of FIG. 1;

FIG. 3 is a bottom end view of the lure storage device of FIG. 1;

FIG. 4 is a top end view of the lure storage device of FIG. 1;

FIG. 5 is a perspective view of the lure storage device of FIG. 1;

FIG. 6 is a perspective view of the lure storage device of FIG. 1; and

FIG. 7 is a perspective view of the lure storage device of FIG. 1 showing padding members.

### DESCRIPTION OF THE INVENTION

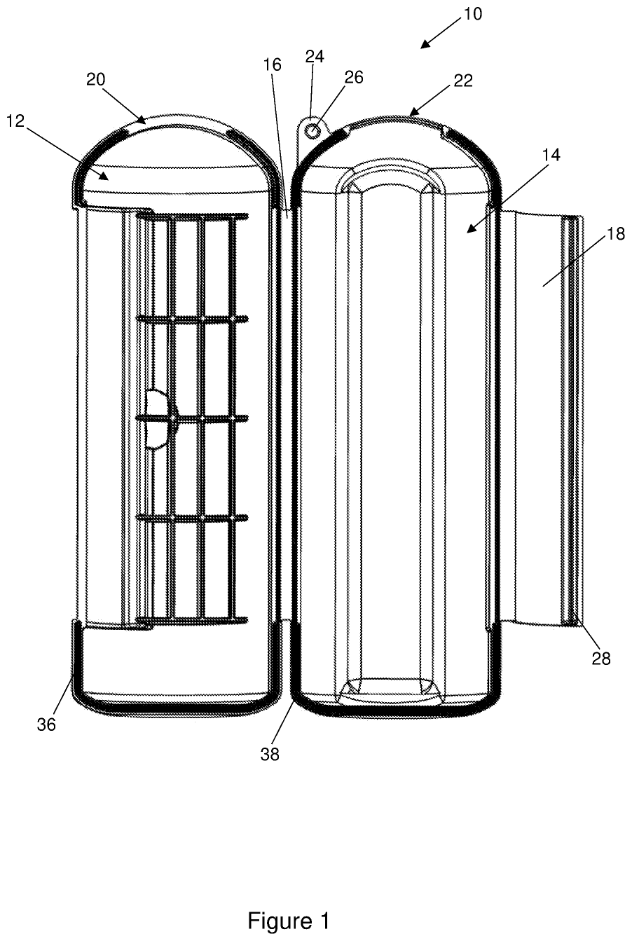

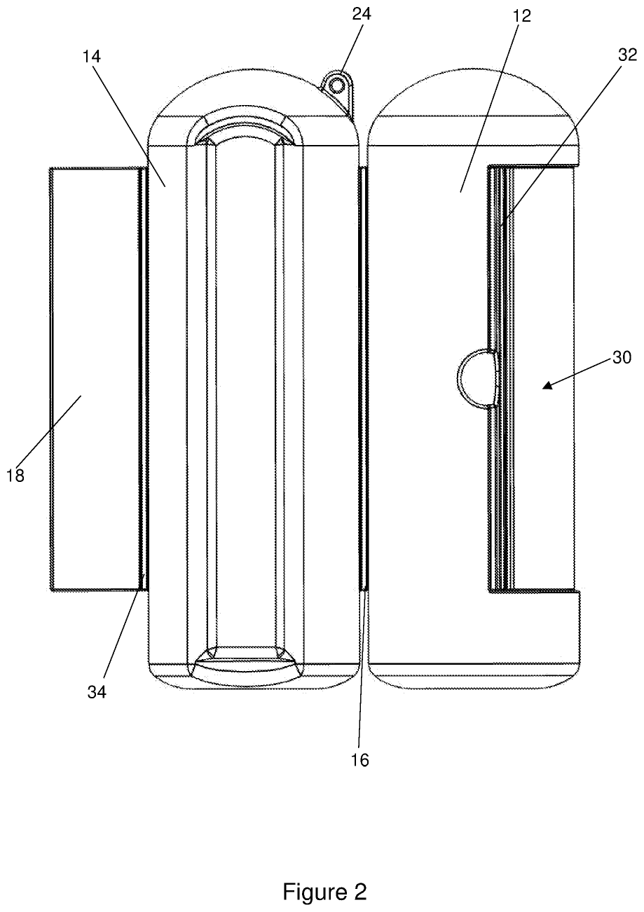

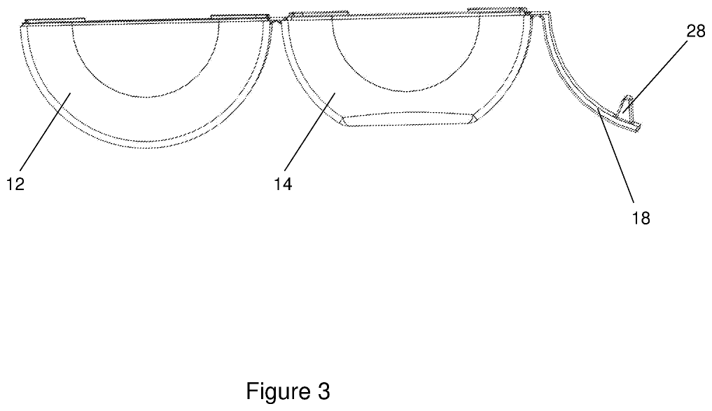

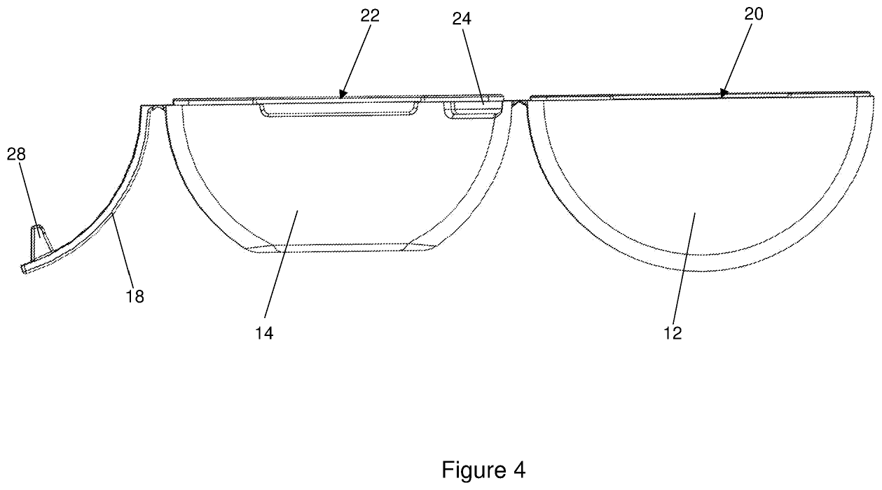

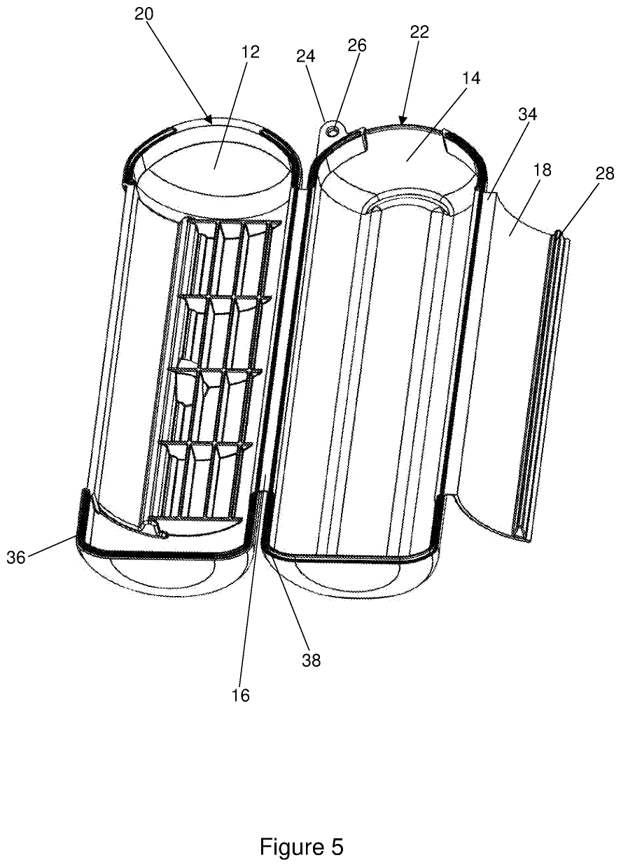

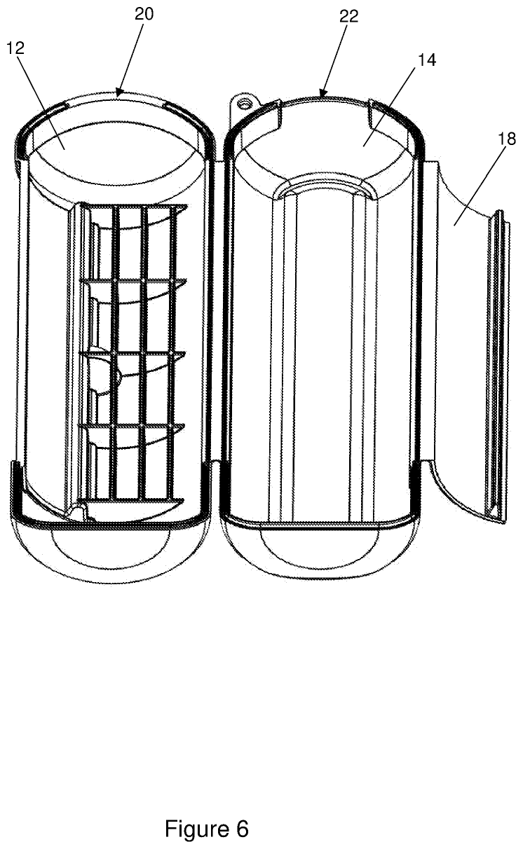

With reference to FIGS. 1 to 6 there is shown a lure storage device 10 according to an embodiment of the present invention. The lure storage device 10 has a compartment portion 12. The compartment portion 12 defines an internal space adapted to at least partially accommodate a fishing lure (not shown).

The lure storage device 10 has a cover portion 14. The cover portion 14 is hingedly attached to the compartment portion 12 by a hinge portion 16. The cover portion 14 is movable relative to the compartment portion 12 between a closed position (not shown) in which the cover portion 14 abuts the compartment portion 12 and substantially closes access to the internal space, and an open position in which the internal space is accessible.

The lure storage device 10 has a catchment portion 18 hingedly attached to the cover portion 14 by a flexible portion 34. The catchment portion 18 is movable between an unlocked condition (shown) in which the compartment portion 12 and the cover portion 14 can move between the open position (shown) and the closed position (not shown), and a secured condition (not shown) in the closed position in which the catchment portion 18 is releasably attached to the compartment portion 12. The compartment portion 12 has an indentation 30 which is adapted to accommodate the catchment portion 18 in the secured position. The indentation 30 also includes a groove 32 which can retain a lip 28 of the catchment portion 18 to releasably secure the catchment portion to the compartment portion.

The compartment portion 12 has furrow 20. The cover portion 14 has a furrow 22. In the closed position (not shown), furrows 20,22 define a recess to accommodate a fishing line attached to the lure (not shown).

The lure storage device 10 includes an attachment portion 24. The attachment portion 24 has an aperture 26 so that the lure storage device 10 can be suspended using a string, rope, lanyard or the like. When suspended by the attachment portion, the recess defined by furrows 20,22 in the closed condition is located towards a top portion of the lure storage device, inhibiting liquids from escaping the lure storage device 10.

The lure storage device 10 has a seal member 36 associated with the compartment portion 12. The lure storage device 10 has a seal member 38 associated with the cover portion 14. The seal members 36,38 substantially seal the lure storage device 10 in the closed condition, inhibiting liquids from leaking out of the lure storage device 10.

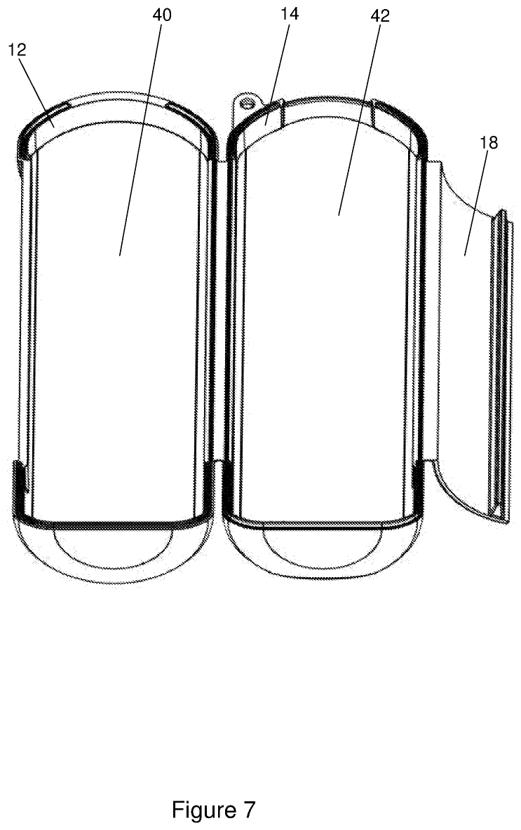

With reference to FIG. 7 there is shown the lure storage device 10 including a padding member 40 located in the compartment portion. The lure storage device 10 also includes a padding member 42 located in the cover portion 14. The padding members 40,42 are adapted to cushion a lure (not shown) when it is located within the lure storage device 10 in the closed position. The padding members 40,42 are made predominantly of an absorbent open cell foamed material. The padding members 40,42 are adapted to retain a liquid, such as a chemical attractant, which can be transferred to a lure when it is located within the lure storage device in the closed position.

### Advantages

An advantage of the preferred embodiment of the lure storage device includes the ability to store a lure while the lure is connected to a fishing line which extends externally to the lure storage device. Another advantage of the preferred embodiment of the lure storage device includes the ability to retain or apply a chemical attractant on a lure in storage. A further advantage of the preferred embodiment of the lure storage device includes the ability to reuse a lure without requiring the lure to be removed from and reattached to a fishing line between uses. Another advantage of the preferred embodiment of the lure storage device includes the ability to retain a liquid within the lure storage device. Another advantage of the preferred embodiment of the lure storage device includes inhibiting contact between a chemical attractant on a lure and a user's hands.

### Variations

While the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A lure storage device having
a compartment portion defining an internal space, the internal space adapted to at least partially accommodate a lure;
a cover portion hingedly attached to the compartment portion, the cover portion movable relative to the compartment portion between a closed position in which the cover portion abuts the compartment portion and substantially closes access to the internal space internal of the compartment portion, and an open position in which the internal space is accessible; and
a catchment portion attached to one of the compartment portion or the cover portion, the catchment portion movable between an unlocked condition in which the compartment portion and the cover portion can move between the open position and the closed position, and a secured condition in the closed position in which the catchment portion is releasably attached to the other of the compartment portion or the cover portion and retains the compartment portion and the cover portion in the closed position,
wherein in the closed position, the compartment portion and the cover portion define a recess adapted to accommodate a fishing line attached to the lure.

2. The lure storage device as claimed in claim 1, further including a padding member adapted to cushion a lure when the lure is located within the lure storage device in the closed position.

3. The lure storage device as claimed in claim 2, wherein the padding member adapted to retain a liquid which can be transferred to the lure when the lure is located within the lure storage device in the closed position.

4. The lure storage device as claimed in claim 2, wherein the padding member is made of a foamed material.

5. The lure storage device as claimed in claim 1, wherein the lure storage device includes a hinge portion located between the compartment portion and the cover portion, the hinge portion hingedly attaching the compartment portion to the cover portion.

6. The lure storage device as claimed in claim 5, wherein the compartment portion, the cover portion, the catchment portion and the hinge portion are integrally formed.

7. The lure storage device as claimed in claim 1, further including a seal member adapted to at least partially seal between the compartment portion and the cover portion when the compartment portion and the cover portion are in the closed condition.

8. The lure storage device as claimed in claim 1, further including an attachment portion located on an outer surface of the compartment portion or the cover portion.

9. The lure storage device as claimed in claim 8, wherein the attachment portion includes an aperture and is adapted to be attached to a fishing pole using a lanyard, string, rope or the like.

10. A lure storage device as claimed in claim 1, wherein the lure is a fishing lure.

11. A lure storage device having
a compartment portion defining an internal space, the internal space adapted to at least partially accommodate a lure;
a cover portion hingedly attached to the compartment portion, the cover portion movable relative to the compartment portion between a closed position in which the cover portion abuts the compartment portion and substantially closes access to the internal space internal of the compartment portion, and an open position in which the internal space is accessible;
a catchment portion attached to one of the compartment portion or the cover portion, the catchment portion movable between an unlocked condition in which the compartment portion and the cover portion can move between the open position and the closed position, and a secured condition in the closed position in which the catchment portion is releasably attached to the other of the compartment portion or the cover portion and retains the compartment portion and the cover portion in the closed position;
a padding member located at least partially within one of the compartment portion or the cover portion, the padding member adapted to cushion the lure when the lure is located within the lure storage device in the closed position; and
a seal member adapted to at least partially seal between the compartment portion and the cover portion when the compartment portion and the cover portion are in the closed condition,
wherein in the closed position, the compartment portion and the cover portion define a recess adapted to accommodate a fishing line attached to the lure.

12. The lure storage device as claimed in claim 11, wherein the padding member is located in the compartment portion.

13. The lure storage device as claimed in claim 11, further including an additional padding member.

14. The lure storage device as claimed in claim 13, wherein the additional padding member is located in the other of the compartment portion or the cover portion.

15. The lure storage device as claimed in claim 11, wherein each padding member is adapted to retain a liquid which can be transferred to the lure when the lure is located within the lure storage device in the closed position.

16. The lure storage device as claimed in claim 15, wherein the liquid is a chemical attractant in the form of a scent.

17. The lure storage device as claimed in claim 16, wherein the lure storage device is a lure scent applicator.

18. A method of storing a lure using a lure storage device as claimed claim 1, the method including the steps of
locating the lure in the compartment portion or the cover portion;
adjusting a fishing line attached to the lure such that in the closed condition, the fishing line is located in the recess;
moving the compartment portion relative to the cover portion to a closed position; and
moving the catchment portion from an unlocked condition to a secured condition in which the catchment portion releasably secures the compartment portion and the cover portion in the closed position.

19. The method as claimed in claim 18, further including the step of providing a padding member to cushion the lure when the lure is located within the lure storage device in the closed position.

20. All method as claimed in claim 18, further including the step of deforming a seal member to accommodate the fishing line in the recess.
